(19) United States
(12) Patent Application Publication
(10) Pub. No.: US 2010/0259646 A1
(43) Pub. Date: Oct. 14, 2010

(54) DATA TRANSFER DEVICE AND CAMERA

(75) Inventors: Masaru KOYAMA, Kamakura-shi (JP); Tsutomu Tamura, Tokyo (JP); Mika Ikeya, Tokyo (JP); Yumiko Nishimiya, Fujisawa-shi (JP)

Correspondence Address: OLIFF & BERRIDGE, PLC, P.O. BOX 320850, ALEXANDRIA, VA, 22320-4850, US

(73) Assignee: NIKON SYSTEMS INC., Yokohama-shi (JP)

(21) Appl. No.: 12/821,833

(22) Filed: Jun. 23, 2010

Related U.S. Application Data
(63) Continuation of application No. PCT/JP2009/000013, filed on Jan. 6, 2009.

(30) Foreign Application Priority Data
Jan. 7, 2008 (JP) 2008-000396

(51) Int. Cl. H04L 7/00; H04B 17/00; H04N 5/76; G06F 3/00

(52) U.S. Cl. 348/231.99; 375/224; 375/226; 710/19; 348/E05.001

(57) ABSTRACT

A data transfer device transfers a data signal being digital in synchronization with a clock signal and includes a delay section, a measurement section, and a control section. The delay section controls a delay amount given to the data signal. The measurement section acquires an acquisition timing of the data signal output from the delay section using test data transmitted at least once prior to data communication and the clock signal. The control section determines the delay amount for the data signal during a period of data communication based on the acquisition timing or a stored timing.

### CROSS REFERENCE TO RELATED APPLICATION

This application is a continuation application of International Application PCT/JP2009/000013, filed Jan. 6, 2009, designating the U.S., and claims the benefit of priority from Japanese Patent Application No. 2008-000396, filed on Jan. 7, 2008, the entire contents of which are incorporated herein by reference.

### BACKGROUND

1. Field

The present application relates to a data transfer device and a camera.

2. Description of the Related Art

Conventionally, in designing an electronic device for the purpose of high-speed transfer of digital data, control of the impedance of a transfer path, equal-length wiring, and selection of a material of a printed circuit board, etc. are performed and after that, a simulation of a signal waveform is performed, and thus the valid period of data (eye pattern) is secured.

In particular, in the parallel system, in which data transfer is performed using a plurality of signal lines, when the order of transfer rate increases close to gigahertz, there is a limit by only the countermeasures, such as equal-length wiring, and it is known that the influence of jitter (fluctuation in delay time of a data signal) makes it difficult to achieve stable, high-speed transfer. In Japanese Unexamined Patent Application Publication No. 2004-171254, an example of a data transfer device is disclosed, which corrects variations in delay between signals in the parallel system data transfer.

However, the above-mentioned prior art has a room for improvement in that the unstable factors that bring problems at the time of high-speed transfer of digital data are still difficult to cope with.

### SUMMARY

A data transfer device according to one embodiment transfers a data signal being digital in synchronization with a clock signal and includes a delay section, a measurement section, and a control section. The delay section controls a delay amount given to the data signal. The measurement section acquires an acquisition timing of the data signal output from the delay section using test data transmitted prior to data communication and the clock signal. The control section determines the delay amount for the data signal during a period of the data communication based on the above-mentioned acquisition timing.

In the above-mentioned one embodiment, the test data may be a binary data string which changes its value alternately in the same cycle as that of the clock signal. Then, the measurement section may sequentially acquire signal values of the test data while changing the delay amount stepwise and may obtain a rising position and a falling position of a signal waveform of the test data from a change in the signal value of two pieces of test data having different delay amounts. Further, the control section may determine the delay amount based on the rising position and the falling position of the signal waveform. Furthermore, the measurement section may acquire, when obtaining the rising position and the falling position of the signal waveform, the signal value of the test data a plurality of times with the delay amount being same and also determine whether the signal value is continuously the same or not to determine the delay amount based on a range in which the signal value has a same value.

In the above-mentioned one embodiment, the data transfer device may include an output device and an input device, the output device has the delay section and the control section and the input device has the measurement section. Further, the control section may determine the delay amount based on the acquisition timing fed back from the measurement section.

In the above-mentioned one embodiment, the data transfer device may have a plurality of channels which transfer data signal in parallel. Further, the delay section, the measurement section, and the control section may operate independently for each of the channels.

In the above-mentioned one embodiment, the data transfer device may further include a memory section that stores a correspondence relationship between an output pattern until a value of the data signal changes and a magnitude of a jitter which occurs in the data signal after the change, a monitoring section that detects the change in the value of the data signal and the output pattern based on the value of the data signal, and a waveform adjusting section that restores a pulse width of the data signal based on the magnitude of the jitter corresponding to the output pattern when the change in the value of the data signal is detected.

The data transfer device in the above-mentioned one embodiment may further include a delay amount memory section that stores the delay amount. Then, the data transfer device may operate based on the delay amount being stored.

A data transfer device according to another embodiment transfers a data signal being digital in synchronization with a clock signal and includes a memory section, a monitoring section, and a waveform adjusting section. The memory section stores a correspondence relationship between an output pattern until a value of the data signal changes and a magnitude of a jitter which occurs in the data signal after the change. The monitoring section detects the change in the value of the data signal and the output pattern based on the value of the data signal. The waveform adjusting section restores a pulse width of the data signal based on the magnitude of the jitter corresponding to the output pattern when the change in the value of the data signal is detected.

A camera including the data transfer device in the above-mentioned one embodiment or the other embodiment, and the configuration concerning the data transfer device in the above-mentioned one embodiment or the other embodiment which is represented as a data transfer system including a plurality of devices and as a data transfer method are also effective as specific embodiments of the present application.

### BRIEF DESCRIPTION OF THE DRAWINGS

FIG. 1 is a schematic diagram showing a configuration example of a data transfer device according to a first embodiment.

FIG. 2 is a schematic diagram showing a configuration example of a delay processing section.

FIG. 3 is a flowchart showing a setting example of a delay amount in a first delay circuit in the first embodiment.

FIG. 4 is a timing chart showing a setting example of a delay amount in the first delay circuit.

FIG. 5 is a timing chart for explaining the restoration of a signal waveform during the period of data communication.

FIG. 6 is a schematic diagram showing a configuration example of a data transfer device according to a second embodiment.

FIG. 7 is a flowchart showing a setting example of a delay amount in the first delay circuit in a third embodiment.

FIG. 8 is a diagram showing a relationship between an acquisition position of a signal waveform and a digital level.

### DETAILED DESCRIPTION OF THE EMBODIMENTS

### Explanation of First Embodiment

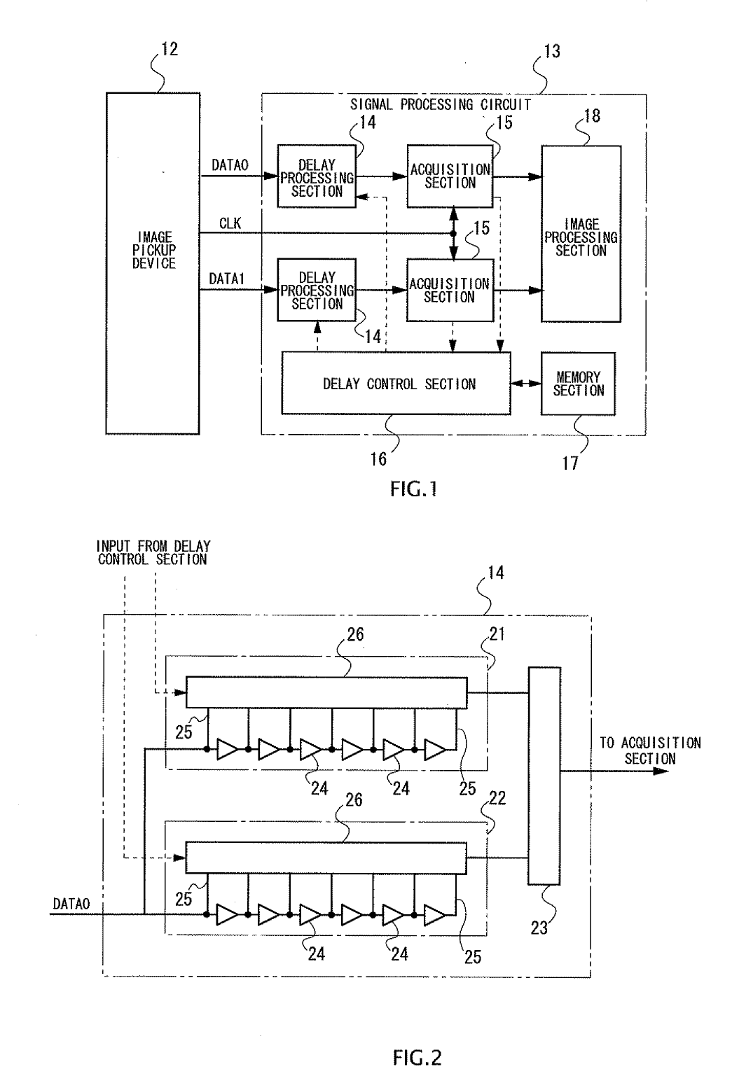

FIG. 1 is a schematic diagram showing a configuration example of a data transfer device according to a first embodiment. FIG. 1 shows a configuration example in which an image pickup device 12 of a camera is an output device and a signal processing circuit 13 of the camera an input device.

The image pickup device 12 in the first embodiment has a light-receiving surface on which a plurality of light-receiving elements is arrayed two-dimensionally, and outputs an image signal of a subject image formed on the light-receiving surface through an imaging optical system (not shown schematically). Further, the image pickup device 12 has an on-chip A/D conversion circuit (not shown schematically) and a digital data signal is output from an output terminal of the image pickup device 12.

Here, to the image pickup device 12 in the first embodiment, one ends of two signal lines (DATA0, DATA1) that output image signals in parallel and one end of a signal line (CLK) that outputs a clock signal are connected. The other end of each of the above-mentioned signal lines is connected to the signal processing circuit 13, respectively, and in the data transfer between the image pickup device 12 and the signal processing circuit 13, it is possible to transfer image signals in a parallel system with two channels. The image pickup device 12 also has a function to output test data, to be described later, to the signal lines DATA0 and DATA1.

The signal processing circuit 13 is a digital front end circuit that performs various kinds of image processing on a digital image signal input from the image pickup device 12. The signal processing circuit 13 has two delay processing sections 14 and two acquisition sections 15, respectively, a delay control section 16, a memory section 17, and an image processing section 18. The delay processing section 14, the acquisition section 15, and the memory section 17 described above are connected to the delay control section 16, respectively. The image processing section 18 is an ASIC that performs various kinds of image processing (defective pixel correction, color interpolation processing, gradation correction, white balance adjustment, edge enhancement, etc.) on a digital image signal.

One sets of the delay processing section 14 and the acquisition section 15 described above are arranged for the signal lines DATA0 and DATA1, respectively. The delay processing section 14 and the acquisition section 15 in each set are connected in series and the delay processing section 14 is connected with one of the signal lines DATA0 and DATA1. Then, the output of each of the acquisition sections 15 is connected with the image processing section 18, respectively. Each of the acquisition sections 15 is connected with the signal line CLK. The configurations of the delay processing section 14 and the acquisition section 15 in respective sets are common with each other. Hence, in the first embodiment, only the delay processing section 14 and the acquisition section 15 connected to the signal line DATA0 are explained but the explanation of the delay processing section 14 and the acquisition section 15 concerning the signal line DATA1 is omitted.

The delay processing section 14 is a circuit that controls the delay amount of a data signal of the signal line DATA0. FIG. 2 is a schematic diagram showing a configuration example of the delay processing section 14. The delay processing section 14 has a first delay circuit 21, a second delay circuit 22, and an output control circuit 23. The signal line DATA0 is connected to the first delay circuit 21 and the second delay circuit 22, respectively. Further, the outputs of the first delay circuit 21 and the second delay circuit 22 are connected to the output control circuit 23 and the output of the output control circuit 23 is connected to the acquisition section 15.

The first delay circuit 21 and the second delay circuit 22 in the first embodiment have the same configuration. Each delay circuit has a plurality of delay elements 24 (inverter etc.) connected in series in multiple stages, a plurality of paths 25 connected with the output of each of the delay elements 24, and a selector 26 that selects any one of the above-mentioned paths 25. Then, in accordance with the path 25 selected by the selector 26, the delay amount of the data signal output from each delay circuit is controlled. The number of delay stages in the delay circuit is designed so as to correspond to several times the cycle of the data transfer.

Here, the first delay circuit 21 functions to adjust the delay amount of the data signal with respect to the clock signal. On the other hand, the second delay circuit 22 is used to restore a signal waveform when a jitter occurs in the data signal. The output control circuit 23 synthesizes the output of the first delay circuit 21 and the output of the second delay circuit 22 and output it to the acquisition section 15.

The acquisition section 15 acquires a value indicated by the data signal in synchronization with the rising or falling timing of the clock signal. Then, the acquisition section 15 outputs the value indicated by the data signal to the image processing section 18 and the delay control section 16. It is assumed that the acquisition section 15 in an operation example, to be described later, acquires the value of the data signal at the rising timing of the clock signal.

The delay control section 16 is a processor that independently controls the delay processing section 14 and the acquisition section 15 in each set, respectively. For example, the delay control section 16 determines the delay amounts of the first delay circuit 21 and the second delay circuit 22 based on the output of the acquisition section 15. The delay control section 16 monitors the output pattern of the data signal based on the output of the acquisition section 15 and controls the operation of the second delay circuit 22 in accordance with the output pattern.

The memory section 17 includes a memory medium, such as a register. In the memory section 17, the data of the delay amount in the first delay circuit 21 (the number of delay stages in the delay circuit), table data, to be described later, etc., are recorded.

Next, an operation example of the data transfer device in the first embodiment is explained. In the first embodiment, the timing adjustment of a data signal is performed in the first delay circuit 21 and the restoration of a signal waveform that has changed due to jitter is performed in the second delay circuit 22. Hereinafter, the operation relating to the first delay circuit 21 and the operation relating to the second delay circuit 22 are explained, respectively. In the following examples, only the case of the signal line DATA0 is explained for the sake of simplicity, however, it is assumed that the same processing is actually performed in parallel for the signal line DATA1.

(Setting Example of Delay Amount in First Delay Circuit)

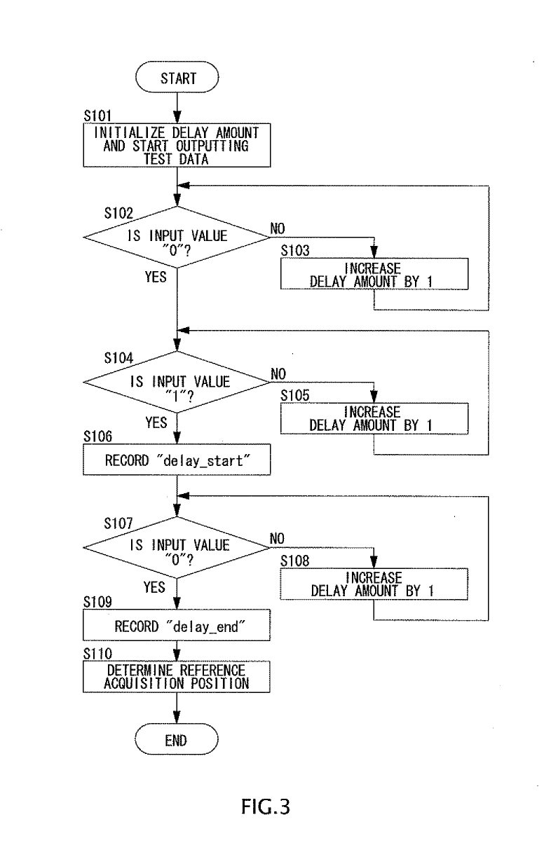

First, a setting example of a delay amount in the first delay circuit 21 is explained with reference to a flowchart in FIG. 3. The processing in FIG. 3 is performed at a timing, such as immediately after the power of a cameral is turned on or immediately before the data of a recorded image is transferred. In the processing in FIG. 3, the delay control section 16 determines the delay amount in the first delay circuit 21 using test data output from the image pickup device 12. The test data in this case includes a binary data string in which “0” and “1” are repeated in the same cycle as that of the clock signal.

Step S101: the delay control section 16 initializes the delay amount of the first delay circuit 21 and also instructs the image pickup device 12 to start outputting test data. Test data is thereby output from the image pickup device 12 to each signal line (DATA0, DATA1) in synchronization with the clock signal. Then, the test data of the signal line DATA0 is input to the acquisition section 15 via the first delay circuit 21 and the output control circuit 23. At this time, the delay control section 16 disables in advance the output from the second delay circuit 22.

Step S102: the delay control section 16 determines whether or not the value input from the acquisition section 15 at the rising timing of the clock signal is “0”. When the above-mentioned requirement is satisfied (YES side), the delay control section 16 moves to S104. On the other hand, when the above-mentioned requirement is not satisfied (NO side), the delay control section 16 moves to S103.

Step S103: the delay control section 16 increases the delay amount of the first delay circuit 21 (the number of delay stages of the delay circuit) by “1” to lag the phase. After that, the delay control section 16 returns to S102 and repeats the above-mentioned operation. The loop from the NO side in S102 to S103 corresponds to the operation to temporarily shift the acquisition position of the data signal to the “0” value in order to search for the rising position of the signal waveform of the test data.

Step S104: the delay control section 16 determines whether or not the value input from the acquisition section 15 at the rising timing of the clock signal is “1”. When the above-mentioned requirement is satisfied (YES side), the delay control section 16 moves to S106. On the other hand, when the above-mentioned requirement is not satisfied (NO side), the delay control section 16 moves to S105.

Step S105: the delay control section 16 increases the delay amount of the first delay circuit 21 by “1” to lag the phase. After that, the delay control section 16 returns to S104 and repeats the above-mentioned operation. The loop from the NO side in S104 to S105 corresponds to the operation to shift the acquisition position of the data signal to the rising position of the signal waveform of the test data.

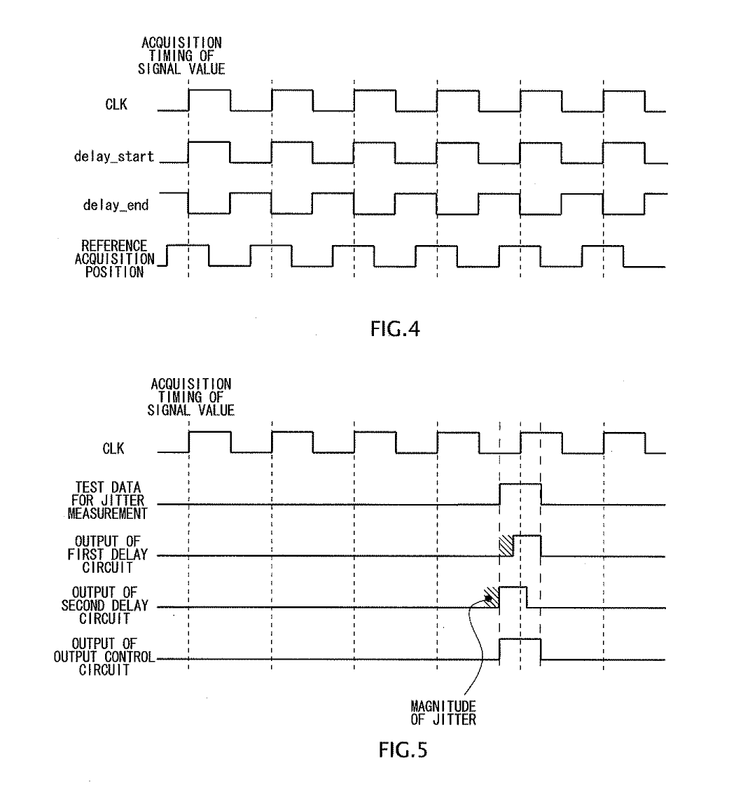

Step S106: the delay control section 16 temporarily records the current delay amount of the first delay circuit 21 as “delay_start” in the memory section 17. The delay amount “delay_start” recorded in S106 corresponds to the rising position of the signal waveform of the test data (refer to FIG. 4).

Step S107: the delay control section 16 determines whether or not the value input from the acquisition section 15 at the rising timing of the clock signal is “0”. When the above-mentioned requirement is satisfied (YES side), the delay control section 16 moves to S109. On the other hand, when the above-mentioned requirement is not satisfied (NO side), the delay control section 16 moves to S108.

Step S108: the delay control section 16 increases the delay amount of the first delay circuit 21 by “1” to lag the phase. After that, the delay control section 16 returns to S107 and repeats the above-mentioned operation. The loop from NO side in S107 to S108 corresponds to the operation to shift the acquisition position of the data signal to the falling position of the signal waveform of the test data.

Step S109: the delay control section 16 temporarily records the current delay amount of the first delay circuit 21 as “delay_end” in the memory section 17. The delay amount “delay_end” recorded in S109 corresponds to the falling position of the signal waveform of the test data (refer to FIG. 4).

Step S110: the delay control section 16 determines the delay amount of the first delay circuit 21 (the reference acquisition position of the data signal) during the period of data communication using the delay amount “delay_start” acquired in S106 and the delay amount “delay_end” acquired in S109. Specifically, the delay control section 16 calculates the reference acquisition position of the data signal by the following expression (1) in S110.

Reference acquisition position=(delay_end−delay_start)/2+delay_start (1)

The above-mentioned reference acquisition position obtained in S110 is located in the middle of the rising position and the falling position of the signal waveform of the test data as a result (refer to FIG. 4). Hence, during the period of data communication to be established after the above-mentioned setting, the acquisition timing of the data signal is stabilized by the delay amount given in the first delay circuit 21 (S110), and therefore, code errors during the period of data transfer are reduced.

The above-mentioned reference acquisition position is determined by the actually measured value of the test data that is actually transferred on the device in which the delay amount is adjusted without using a simulator, dummy circuit, or the like. It is therefore unlikely that trouble occurs due to a difference between the delay amount obtained from the design and the actual delay amount.

Further, even when there is an error in, for example, each path of the first delay circuit 21 due to the variations in the wire length and element, it is possible for the delay control section 16 to determine an appropriate reference acquisition position using the actually measured value including the amount of the error. Hence, errors resulting from the variations in the wire length and element or the change in environment are absorbed by the above-mentioned setting operation, and therefore, it is possible to further improve the reliability of the data transfer device. By the above-mentioned setting operation, the amount of the error in each path in the first delay circuit 21 can be absorbed, and therefore, it is possible to set large the allowable error in the first delay circuit 21 or to avoid the design of the equal-length wiring in the first delay circuit 21, which can improve the degree of freedom in design.

In the above-mentioned setting operation, the binary data string in which the values change alternately in the same cycle as that of the clock signal is used as test data, and therefore, when the rising position and the falling position of the signal waveform are searched for (S102, S104, S107), the output value of the test data is constant, that is, “0” or “1” in the acquisition position other than the indefinite interval, which makes it possible to obtain an appropriate delay amount by obtaining the delay amount using the data.

Hence, for example, when the rising position and the falling position of the waveform are searched for by calculating an exclusive OR of the outputs of the two anteroposterior paths, it is necessary to operate the circuit used for determination at least at the transfer rate of the data communication, however, according to the first embodiment, it is also made possible to determine the change in the output value between the paths of the first delay circuit 21 even when using the delay control section 16 the drive frequency of which is lower than the transfer rate of the data communication.

Further, in the first embodiment, it is possible to adjust the delay amount independently for the signal line DATA0 and the signal line DATA1, respectively. Hence, for the data transfer device in the parallel system, the design of the equal-length wiring can be avoided and the degree of freedom in layout of the elements and wires is improved considerably at the time of designing.

(Setting Example of Delay Amount in Second Delay Circuit)

Next, a setting example of the delay amount in the second delay circuit 22 is explained. First, the delay control section 16 obtains in advance a correspondence relationship between the output pattern of a data signal and the magnitude of the jitter in the output pattern.

Here, the delay control section 16 obtains the above-mentioned correspondence relationship using test data for jitter measurement. The test data for jitter measurement has a plurality of output patterns and each output pattern includes a combination of signal values that can result from the jitter. Specifically, when a signal value changes after the identical signal value continues a plurality of times, the pulse width of the signal value that has changed is shortened by the jitter. Hence, the output pattern of the test data for jitter measurement is an array of two values only the last bit of which is different, for example, “1110” or “0001”.

Specifically, the setting of the delay amount is performed in the second delay circuit 22 by, for example, the following (1) to (4) processes. When the delay amount in the second delay circuit 22 is set in advance and table data, to be described later, is present in the memory section 17, it is also possible for the delay control section 16 to omit the processing in the following (1) to (4) processes.

(1) The delay control section 16 initializes the delay amount of the second delay circuit 22. At this time, the delay control section 16 disables the output from the first delay circuit 21 in advance.

(2) The delay control section 16 specifies the test data for jitter measurement used for measurement and also instructs the image pickup device 12 to start outputting the specified test data for jitter measurement.

(3) The delay control section 16 obtains the magnitude of the jitter when the signal value of the output pattern changes using the test data for jitter measurement in the above-mentioned (2) process. Specifically, the delay control section 16 acquires an actually measured value corresponding to the last bit at the rising timing of the clock signal by the acquisition section 15. Then, the delay control section 16 compares the above-mentioned actually measured value of the acquisition section 15 with the signal value of the last bit and reduces the delay amount of the second delay circuit 22 (the number of delay stages of the delay circuit) to lead the phase until both the values coincide with each other. When the above-mentioned actually measured value of the acquisition section 15 and the signal value of the last bit coincide with each other, the delay control section 16 records the current delay amount of the second delay circuit 22 in the memory section 17 as the magnitude of the jitter corresponding to the output pattern.

(4) After that, the delay control section 16 changes the test data for jitter measurement and repeats the operations in the above-mentioned (1) to (3) processes. The delay control section 16 thereby generates table data indicative of a correspondence relationship between the output pattern of each data signal and the magnitude of the jitter in the output pattern.

Next, the restoration operation of the signal waveform during the period of data communication is described in detail. In the initial state during the period of data communication, the delay control section 16 adjusts the delay amount of the first delay circuit 21 and the delay amount of the second delay circuit 22 so that the output of the first delay circuit 21 and the output of the second delay circuit 22 synchronize with each other. In this state, the data signal of the signal line DATA0 passes through the first delay circuit 21 or the second delay circuit 22 in parallel and is output to the acquisition section 15 via the output control circuit 23. In the output control circuit 23, the value of the data signal is acquired at the rising timing of the clock signal. Then, the value of the data signal is input to the image processing section 18 and the delay control section 16.

During the period of data communication, the delay control section 16 monitors the signal value of the signal line DATA0 and when an identical signal value continues, the output value is held in an internal register (not shown schematically). The delay control section 16 refers to the output pattern of the table data in the memory section 17 and reads an output pattern the high order bits except for the last bit of which coincide with the above-mentioned output value.

For example, when the output value held in the register is “000”, the delay control section 16 searches for the output pattern of “0001” from the table data. Then, the delay control section 16 advances the phase in the second delay circuit 22 based on the delay amount of the second delay circuit 22 corresponding to the read output pattern.

Here, when the identical signal value further continues, the output value of the first delay circuit 21 is the same as that of the second delay circuit 22, and hence, the signal value output from the output control circuit 23 does not change in particular. In this case, the number of bits of the output value held in the register increases, and hence, the delay control section 16 rereads a different output pattern by referring to the output pattern of the table data in the memory section 17. Then, the delay control section 16 further leads the phase in the second delay circuit 22 based on the delay amount of the second delay circuit 22 corresponding to the read output pattern.

On the other hand, when the signal value changes in the above-mentioned state, the phase in the second delay circuit 22 leads by an amount corresponding to the occurrence of jitter, and hence, the rising of the signal waveform is earlier in the second delay circuit 22. The falling of the signal waveform is later in the first delay circuit 21. At this time, the output control circuit 23 adjusts the pulse width of the output signal by matching the rising of the signal waveform with the output of the second delay circuit 22 and on the other hand, by matching the falling of the signal waveform with the output of the first delay circuit 21 (refer to FIG. 5). When the signal value changes, the delay control section 16 resets the output value of the register.

Then, the delay control section 16 repeats the above-mentioned operations during the period of data communication. Thereby, in the data signal output from the output control circuit 23, the pulse width corresponding to the jitter is restored. As a result, it is made possible to stably acquire the data signal and the code error during the period of data transfer is reduced.

### Explanation of Second Embodiment

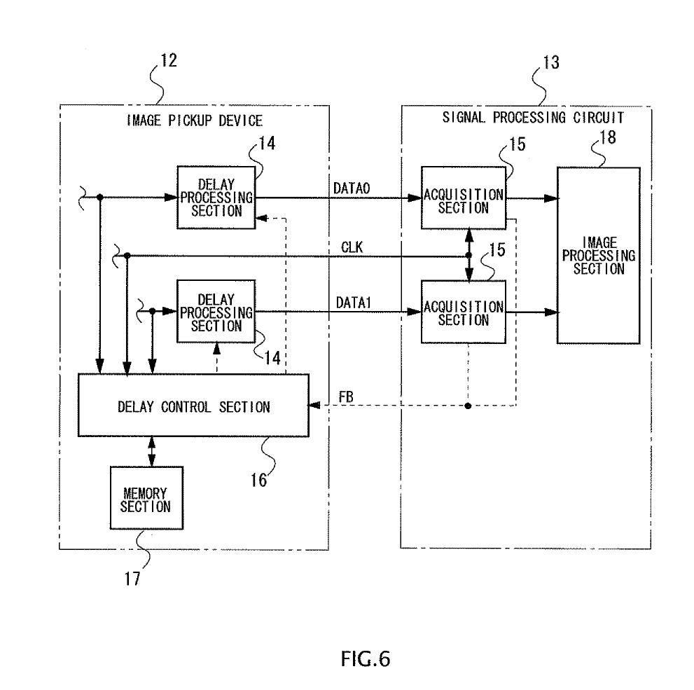

FIG. 6 is a schematic diagram showing a configuration example of a data transfer device according to a second embodiment. The second embodiment shown in FIG. 6 is a modified example of FIG. 1 and the same symbols are attached to the components common to those in FIG. 1 and duplicated explanation is omitted.

In the data transfer device in FIG. 6, the delay processing section 14 and the delay control section 16 are provided on the side of the output device (image pickup device 12) and the acquisition section 15 is provided on the side of the input device (signal processing circuit 13). Then, to the data signal output to the input device, the delay amount is given in advance in the delay processing section 14 on the side of the output device.

The delay control section 16 on the side of the output device and the acquisition section 15 on the side of the input device are connected by a signal line FR for feedback control. Then, the acquisition section 15 on the side of the input device feeds back the value of the data signal acquired via the signal line FR to the delay control section 16, which adjusts the delay amount in the delay processing section 14 based on the result in the same manner as that in the above-mentioned first embodiment. In the case of a parallel data transfer device, the signal line FR may be provided for each channel, however, it is made also possible to control using one signal line FR as shown in FIG. 6 by performing the setting operation of the delay amount in each channel in a time sharing manner.

With the data transfer device in the second embodiment, the same effect as that of the above-mentioned first embodiment can be obtained.

### Explanation of Third Embodiment

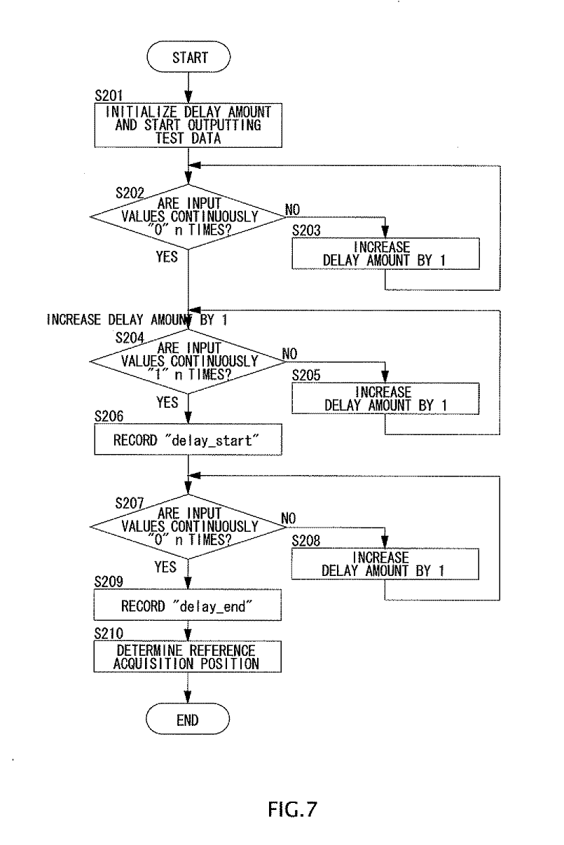

FIG. 7 is a flowchart showing a setting example of a delay amount in a first delay circuit in a third embodiment. Processing shown in FIG. 7 is a modified example of the processing in FIG. 3 in the first embodiment.

Here, the configuration of a data transfer device in the third embodiment is common to that in FIG. 1, and thus, its duplicated explanation is omitted. Processing in S201, S209, and S210 in FIG. 7 corresponds to the processing in S101, S109, and S110 in FIG. 3, respectively, and thus, its duplicated explanation is omitted.

Step S202: the delay control section 16 acquires a value a plurality of times (n times) from the acquisition section 15 at the rising timing of a clock signal. The above-mentioned number of times of acquisition n may be set appropriately in accordance with the degree of stability of the transfer path of data communication.

Then, the delay control section 16 determines whether or not the values input n times from the acquisition section 15 are continuously “0”. When the above-mentioned requirement is satisfied (YES side), the delay control section 16 moves to S204. On the other hand, when the above-mentioned requirement is not satisfied (NO side), the delay control section 16 moves to S203. In the indefinite interval in which the input values are “0” or “1” in an unstable manner, the delay control section 16 makes determination of the NO side in S202.

Step S203: the delay control section 16 increases the delay amount of the first delay circuit 21 (number of delay stages of the delay circuit) by “1” to lag the phase. After that, the delay control section 16 returns to S202 and repeats the above-mentioned operation. The loop from the NO side in S202 to the S203 corresponds to the operation to temporarily shift the acquisition position of the data signal to the “0” value excluding the indefinite interval in order to search for the rising position of the signal waveform of the test data.

Step S204: the delay control section 16 acquires a value a plurality of times (n times) from the acquisition section 15 at the rising timing of the clock signal. Then, the delay control section 16 determines whether or not the values input n times from the acquisition section 15 are continuously “1”. When the above-mentioned requirement is satisfied (YES side), the delay control section 16 moves to S206. On the other hand, when the above-mentioned requirement is not satisfied (NO side), the delay control section 16 moves to S205. In the indefinite interval in which the input values are “0” or “1” in an unstable manner, the delay control section 16 makes the determination of the NO side in S204.

Step S205: the delay control section 16 increases the delay amount of the first delay circuit 21 by “1” to lag the phase. After that, the delay control section 16 returns to S204 and repeats the above-mentioned operation. The loop from the NO side in S204 to S205 corresponds to the operation to shift the acquisition position of the data signal to the rising position of the signal waveform excluding the indefinite interval of the test data.

Step S206: the delay control section 16 temporarily records the current delay amount of the first delay circuit 21 as “delay_start” in the memory section 17. S206 corresponds to the processing in S106 in FIG. 3.

Step S207: the delay control section 16 acquires a value a plurality of times (n times) from the acquisition section 15 at the rising timing of the clock signal. Then, the delay control section 16 determines whether or not the values input n times from the acquisition section 15 are continuously “0”. When the above-mentioned requirement is satisfied (YES side), the delay control section 16 moves to S209. On the other hand, when the above-mentioned requirement is not satisfied (NO side), the delay control section 16 moves to S208. In the indefinite interval in which the input values are “0” or “1” in an unstable manner, the delay control section 16 makes the determination of the NO side in S207.

Step S208: the delay control section 16 increases the delay amount of the first delay circuit 21 by “1” to lag the phase. After that, the delay control section 16 returns to S207 and repeats the above-mentioned operation. The loop from the NO side in S207 to S208 corresponds to the operation to shift the acquisition position of the data signal to the falling position of the signal waveform excluding the indefinite interval of the test data. The explanation of FIG. 7 is completed as above.

According to the setting operation in the third embodiment, in addition to the effect of the setting operation in the first embodiment shown in FIG. 3, the following effect can be obtained further.

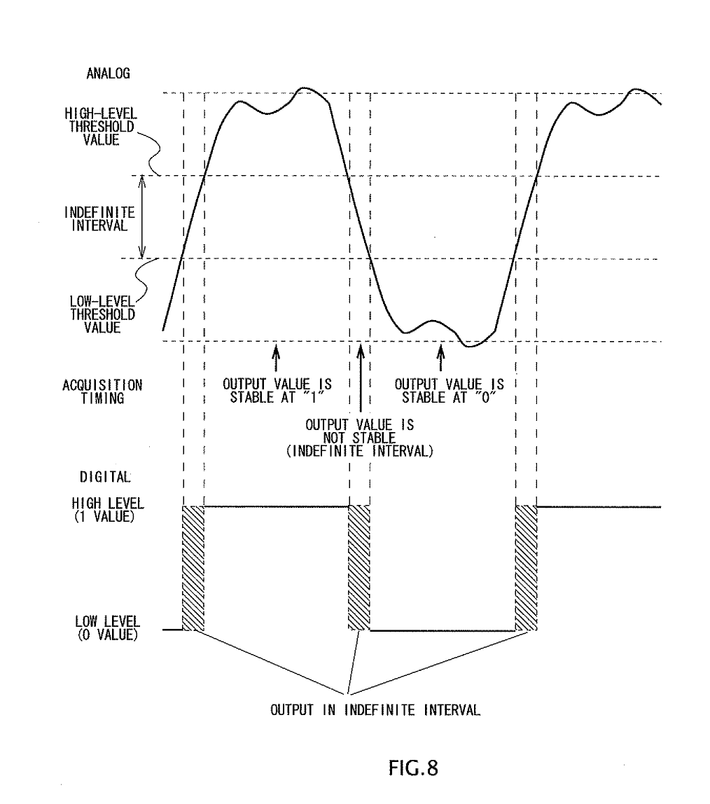

In the data transfer device, depending on the clock and data acquisition timing, there is a possibility that a value of the signal waveform is sampled in the indefinite interval (refer to FIG. 8). The value acquired in the indefinite interval assumes “1” or “0” at any given time, which causes a code error.

The delay control section 16 in the third embodiment therefore also determines whether or not the same value continues n times when searching for the rising position and the falling position of the signal waveform. This makes it possible to obtain with precision the rising position and the falling position of the signal waveform excluding the indefinite interval, and hence, to determine a more appropriate reference acquisition position of the data signal.

### Supplementary Items of Embodiments

(1) In each of the above-mentioned embodiments, the example of the data transfer device that performs parallel transfer using two channels is explained. The number of channels of the data transfer device in the present invention is however not limited to the example of the above-mentioned embodiments, and it is of course possible to apply the present invention to a data transfer device using one channel or a data transfer device that performs parallel transfer using a plurality of channels, that is, more than two channels.

(2) In the above-mentioned embodiments, the example of the data transfer between the image pickup device 12 and the signal processing circuit 13 in a camera is explained, and the data transfer device of the present invention can be however also applied to the data transfer between other elements in the camera. Further, the data transfer device of the present invention can also be applied to a digital processing circuit to be incorporated in another electronic device. Furthermore, the data transfer device of the present invention can also be applied to the wired data transfer between mutually independent electronic devices.

(3) In the second embodiment, it may also be possible to determine whether or not the same value continues n times when searching for the rising position and the falling position of the signal waveform as in the third embodiment.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A data transfer device which transfers a data signal being digital in synchronization with a dock signal, comprising:
a delay section controlling a delay amount given to the data signal;
a measurement section acquiring an acquisition timing of the data signal output from the delay section using test data transmitted prior to data communication and the clock signal; and
a control section determining the delay amount for the data signal during a period of the data communication based on the acquisition timing.

2. The data transfer device according to claim 1, wherein
the test data is a binary data string which changes a value alternately in a same cycle as the clock signal.

3. The data transfer device according to claim 2, wherein
the measurement section sequentially acquires a signal value of the test data while changing the delay amount stepwise and obtains a rising position and a falling position of a signal waveform of the test data from a change in the signal value of two pieces of the test data having different delay amounts, and
the control section determines the delay amount based on the rising position and the falling position of the signal waveform.

4. The data transfer device according to claim 3, wherein
the measurement section acquires, when obtaining the rising position and the falling position of the signal waveform, the signal value of the test data a plurality of times with the delay amount being same and also determines whether the signal value is continuously the same or not to determine the delay amount based on a range in which the signal value has a same value.

5. The data transfer device according to claim 1, wherein
the data transfer device includes an output device and an input device, the output device has the delay section and the control section and the input device has the measurement section, and
the control section determines the delay amount based on the acquisition timing fed back from the measurement section.

6. The data transfer device according to claim 1, wherein
the data transfer device has a plurality of channels which transfer the data signal in parallel, and
the delay section, the measurement section, and the control section operate independently for each of the channels.

7. The data transfer device according to claim 1, further comprising:
a memory section storing a correspondence relationship between an output pattern until a value of the data signal changes and a magnitude of a jitter which occurs in the data signal after the change;
a monitoring section detecting the change in the value of the data signal and the output pattern based on the value of the data signal; and
a waveform adjusting section restoring a pulse width of the data signal based on the magnitude of the jitter corresponding to the output pattern when the change in the value of the data signal is detected.

8. The data transfer device according to claim 1, further comprising
a delay amount memory section storing the delay amount, wherein
the data transfer device operates based on the delay amount being stored.

9. A data transfer device which transfers a data signal being digital in synchronization with a clock signal, comprising:
a memory section storing a correspondence relationship between an output pattern until a value of the data signal changes and a magnitude of a jitter which occurs in the data signal after the change;
a monitoring section detecting the change in the value of the data signal and the output pattern based on the value of the data signal; and
a waveform adjusting section restoring a pulse width of the data signal based on the magnitude of the jitter corresponding to the output pattern, when the change is detected in the value of the data signal.

10. A camera comprising the data transfer device according to claim 1.

11. A camera comprising the data transfer device according to claim 9.
